(19) United States
(12) Patent Application Publication
(10) Pub. No.: US 2012/0044871 A1
(43) Pub. Date: Feb. 23, 2012

(54) METHOD FOR FEEDING BACK ACKNOWLEDGEMENT/NEGATIVE-ACKNOWLEDGEMENT MESSAGE IN MULTI-CARRIER SYSTEM

(76) Inventors: Yingyang Li, Beijing (CN); Xiaogiang Li, Beijing (CN)

(21) Appl. No.: 13/265,992

(22) PCT Filed: Apr. 23, 2010
(86) PCT No.: PCT/KR2010/002544

§ 371 Date: Oct. 24, 2011

(30) Foreign Application Priority Data
Apr. 24, 2009 (CN) 200910137380.2

(51) Int. Cl. H04W 92/00

(52) U.S. Cl. 370/328

(57) ABSTRACT

This invention provides a method for feeding back an acknowledgement/negative-acknowledgement ACK/NACK message The network side of the multi-carrier system sends the downlink control signal in a multi-carrier system, where in multiple comand the downlink data signal via the PDCCH and via the PDSCH over the ponent carriers, a primary component carrier is multiple component carriers supported by the user equipment respectively set for user equipment, and the rest is set as a secondary component carrier, and the method includes: receiving, by the user equipment, a downlink control signal and a downlink data signal sent over the multiple component carriers via a Physical Downlink Control CHannel PDCCH and via a Physical Downlink Shared CHannel PDSCH respectively; and determining, by the user equipment, an ACK/NACK channel corresponding to the PDSCH in the multiple component carriers for feeding back the ACK/NACK message, according to a Control Channel Element CCE index of the PDCCH of the primary component carrier having been set. The method provided by this invention can feed back the ACK/NACK message in the multi-carrier system.

### TECHNICAL FIELD

The present invention relates to the field of wireless communication system, and particularly to a method for feeding back an acknowledgement/negative-acknowledgement (ACK/NACK) message in a multi-carrier system.

### BACKGROUND ART

A wireless communication system includes uplink transmission and downlink transmission. Specifically, the downlink transmission means sending a downlink signal from a base station to user equipment, where the downlink signal includes a downlink data signal, a downlink control signal and a downlink reference signal. The downlink data signal is transmitted via the Physical Downlink Shared CHannel (PDSCH), and the downlink control signal is transmitted via the Physical Downlink Control CHannel (PDCCH). The uplink transmission means sending an uplink signal from the user equipment to the base station, where the uplink signal includes an uplink data signal, an uplink control signal and an uplink reference signal. The uplink data signal is transmitted via the Physical Uplink Shared CHannel (PUSCH), and the uplink control signal is transmitted via the Physical Uplink Control CHannel (PUCCH). The PUCCH includes an ACK/NACK channel corresponding to the PDSCH, for feeding back whether the downlink data signal is received via the corresponding PDSCH thereof. Along with the development of the wireless communication system, the Long Tenn Evolution (LTE) communication system emerges. In the LTE communication system, the downlink transmission uses Orthogonal Frequency Division Multiple Access (OFDMA) techniques, and the uplink transmission uses Signal Carrier Frequency Division Multiple Access (SCFDMA) techniques.

FIG. 1 is a schematic diagram illustrating time-frequency resources occupied by a PUCCH in an LTE communication system in the prior art. As can be seen from this figure, the time-frequency resources occupied by the PUCCH are distributed at the two ends of the frequency band of the LTE communication system. When the time-frequency resources are allocated for the PUCCH, in order to introduce the effects of frequency diversity, in a sub-frame, the PUCCH occupies a Resource Block (RB) (101) at the upper end of the frequency band within the first timeslot and an RB (102) at the lower end of the frequency band within the second timeslot to transmit the uplink control signal, or alternatively, occupies an RB (103) at the lower end of the frequency band within the first timeslot and an RB (104) at the upper end of the frequency band within the second timeslot to transmit the uplink control signal. At present, for the uplink control signal having a standard Cyclic Prefix (CP) frame structure, 36, 18 or 12 ACK/NACK channels may be multiplexed within each RB. For the uplink control signal having a lengthened CP frame structure, 24, 14 or 8 ACK/NACK channels may be multiplexed within each RB. The uplink control signal is an ACK/NACK message, for feeding back whether the downlink data signal is received via the corresponding PDSCH thereof.

In the LTE communication system, the PDCCH is used for dynamically scheduling the transmission of the downlink and/or uplink data signal of the user equipment. The time-frequency resources occupied by the PDCCH are composed of one or more Control Channel Element (CCE), where there are 1, 2, 4 or 8 CCEs. In order to transmit the downlink data signal using Hybrid Automatic Repeat reQuest (HARM) techniques, for each of the user equipment scheduled in the LTE communication system, it is required to determine its ACK/NACK channel used for sending the ACK/NACK message. The specific determination process is as follows: the index of the ACK/NACK channel occupied by the user equipment is bundled with the minimum CCE index of the PDCCH that schedules the user equipment. For the user equipment, n-4 downlink sub-frames are used as the PDSCH to transmit the downlink data signal, and the index of its corresponding ACK/NACK channel is

n_{PUCCH}⁽¹⁾n_{CCE}+N_{PUCCH}⁽¹⁾,

where

n_{CCE}

is the minimum CCE index of the PDCCH that schedules the user equipment,

n_{PUCCH}⁽¹⁾

is a parameter configured in a higher layer. In the LTE communication system, an uplink sub-frame in the ACK/NACK channel is selected to send the ACK/NACK message of the PDSCH of one or more downlink sub-frames. In the practical sending, block interleaving techniques are used to implement mapping. It is assumed that the quantity of these downlink sub-frames is M, and the set of their indexes is K. For the minimum CCE index

n_{CCE,i}

of the PDCCH in the i^{th} downlink sub-frame within the set K, the user equipment firstly selects p in the bit set {0, 1, 2, 3} of the uplink sub-frame that satisfies

Nₚ≦n_{CCE,i}<Nₚ₊₁

and

Nₚ=max{0, └[N_{RB}^{DL}×(N_{sc}^{RB}×p−4)]/36┘},

where

N_{RB}^{DL}

represents the quantity of the RB occupied by the PDCCH,

N_{sc}^{RB}

represents the quantity of the sub-carrier occupied by the RB. Thus, the ACK/NACK channel that the CCE is mapped to is

n_{PUCCH,i}⁽¹⁾=(M−i−1)×N_{P}+i×Nₚ₊₁+n_{CCE,i}+N_{PUCCH}^{(1),}

N_{PUCCH}⁽¹⁾

is a parameter configured in a higher layer.

In the LTE communication system, a multi-bit ACK/NACK message corresponding to multiple downlink sub-frames that transmit the downlink data signal may be sent in an uplink sub-frame of the ACK/NACK channel. The ACK/NACK message feeds back the situation of receiving the downlink data signal via the multiple downlink sub-frames. The multi-bit ACK/NACK includes 2, 3 or 4 bits. FIG. 2 is a schematic diagram illustrating an ACK/NACK message sent via an uplink sub-frame corresponding to multiple downlink sub-frames in the prior art. As can be seen, different bits (bit 1 in the ACK/NACK message, bit 2 in the ACK/NACK message, bit 3 in the ACK/NACK message and bit 4 in the ACK/NACK message) of an uplink sub-frame, which correspond to the downlink sub-frame 1, the downlink sub-frame 2, the downlink sub-frame 3 and the downlink sub-frame 4, are respectively used to feed back whether the downlink data signal transmitted therefrom is received. When receiving the downlink data signal transmitted from the downlink sub-frame, the user equipment may feed back information (which includes ACK, NACK or Discontinuous Transmission (DTX)) on the bit within its corresponding uplink sub-frame. Specifically, if no downlink data signal is received by the user equipment, or the base station has sent the downlink data signal via the downlink sub-frame but the user equipment does not receive the downlink data signal, no feedback is made, i.e. the DTX. If the corresponding user equipment receives the downlink data signal and the Multiple Input Multiple Output (MIMO) techniques are employed in the LTE communication system, the user equipment feeds back the information of the downlink data signal transmitted from the downlink sub-frame (such downlink sub-frame is not differentiated in code word) through the bit within the corresponding uplink sub-frame. If the MIMO techniques are employed, the user equipment feeds back the information of the downlink data signal transmitted from two code words of the downlink sub-frame through the bit within the corresponding uplink sub-frame. That is, if the downlink data signal transmitted from the two code words of the downlink sub-frame is received correctly, the ACK is fed back; and if the downlink data signal transmitted from any of the two code words of the downlink sub-frame is not received correctly, the NACK is fed back.

Every downlink sub-frame of the PDSCH for transmitting the downlink data signal corresponds to an ACK/NACK channel, and the multi-bit ACK/NACK message is sent by selecting an uplink sub-frame in the ACK/NACK channel. Specifically, if it assumed that the ACK/NACK message to be fed back for the downlink data signal sent from N (N is 2, 3 or 4) downlink sub-frames is transmitted in an uplink sub-frame of the ACK/NACK channel, then after the N downlink sub-frames have transmitted the downlink data signal for the user equipment (the N downlink sub-frames correspond to N uplink sub-frames allocated in the ACK/NACK channel), the user equipment selects one from the N uplink sub-frames to feed back the situation that the N downlink sub-frames transmit the downlink data signal. In the selected uplink sub-frame, mapping is performed based on Quadrature Phase Shift Keying (QPSK) techniques, where 4 types of QPSK constellation points are available for mapping. Thus there are 4N sending states for sending the ACK/NACK message. Each sending state is a two-tuples, i.e. the selected uplink sub-frame in the ACK/NACK channel and the QPSK constellation point used. The 4N sending states may indicate, at the very most, 4N different types of ACK/NACK messages. There is also another state, i.e. the DTX (i.e. the user equipment does not feed back the ACK/NACK) that is contained in the ACK/NACK, thus 4N+1 sending states may be used to indicate 4N+1 different types of ACK/NACK messages at the very most.

Along with the development of the LTE communication system, in order to support higher transmission rate, multiple component carriers are combined to implement the LTE communication system in a broader operation bandwidth, which form the uplink and the downlink of the LTE communication system, i.e. Bandwidth Aggregation. This may also be called a multi-carrier LTE communication system, i.e. LTE-A. For example, in order to support a 100 MHz bandwidth for the LTE communication system, 5 component carriers of 20 MHz may be combined to realize this. Therefore, the user equipment being able to receive and/or transmit signals over multiple carriers emerges. In the LTE communication system, if multiple carriers are used, then regarding the multiple carriers supported by a serving cell, the user equipment is configured to receive the downlink data signal over only a part of the component carriers via the PDSCH, and correspondingly, is also configured to send the uplink data signal over a part of the component carriers via the PUSCH. FIG. 3 is a schematic diagram illustrating multiple carriers in the prior art. As can be seen, the 100 MHz communication system bandwidth (301) is composed of 5 component carriers (321˜325) of 20 MHz. The sub-frame of each component carrier includes PDCCH areas (331˜335) and PDSCH areas (341˜345). The PDCCH area of each component carrier is dynamically configured via the Physical Control Format Indicator CHannel (PCFICH) independently. For example, for the component carriers 0 and 4, there are 3 OFDM symbols (331) and 1 OFDM symbol (335) in the PDCCH areas respectively. Thus, there are 11 OFDM symbols (341) in the PDSCH area of the component carrier 0, and there are 13 OFDM symbols (345) in the PDSCH area of the component carrier 4. In FIG. 3, each component carrier sends scheduling allocation signaling independently, and the transmission of each PDCCH is limited within a component carrier. For example, the user equipment (UE) (350) receives two independent scheduling signaling 1 (352) and 2 (353), thus the PDSCH is scheduled in the component carriers 1 and 2 respectively. The UE (360) receives the scheduling signaling 4 (365) over the component carrier 4, and thus receives the downlink data signal sent over the component carrier 4 via the PDSCH. The above method for scheduling the PDSCH is also applicable to the scheduling of the PUSCH. In the multi-carrier system, the principle of allocating uplink time-frequency resources for the user equipment is consistent with FIG. 3, where each component carrier may be divided into a PUCCH area and a PUSCH area. The ACK/NACK message may be transmitted in the PUCCH area. In the multi-carrier system, it is allowed to dynamically schedule the resource in the PUCCH area as the PUSCH.

### DISCLOSURE OF INVENTION

### Technical Problem

However, for the multi-carrier system, the UE may receive the downlink data signal transmitted over various component carriers, but a proposal of how to correspondingly feed back the ACK/NACK message is still unavailable. How to feed back the ACK/NACK message in the multi-carrier system has become an urgent problem to be solved.

### Solution to Problem

In view of the above, the present invention provides a method for feeding back an ACK/NACK message in a multi-carrier system. The method can feed back the ACK/NACK message in the multi-carrier system, and particularly can determine the ACK/NACK channel for feeding back the ACK/NACK message in the multi-carrier system.

The present invention further provides a method for feeding back an ACK/NACK message in a multi-carrier system. The method can feed back the ACK/NACK message in the multi-carrier system, and particularly can reduce the occupied time-frequency resources and improve the feedback rate when the ACK/NACK message is fed back via the determined ACK/NACK channel.

The present invention further provides a method for feeding back an ACK/NACK message in a multi-carrier system. The method can feed back the ACK/NACK message in the multi-carrier system, and particularly can perform sending after mapping is conducted when the ACK/NACK message is fed back via the determined ACK/NACK channel.

In order to achieve the above objects, the technical solutions of embodiments of the present invention are implemented as follows.

A method for feeding back an acknowledgement/negative-acknowledgement ACK/NACK message in a multi-carrier system, wherein in multiple component carriers, a primary component carrier is set for user equipment, and the rest is set as a secondary component carrier, and the method comprises: receiving, by the user equipment, a downlink control signal and a downlink data signal sent over the multiple component carriers via a Physical Downlink Control CHannel PDCCH and via a Physical Downlink Shared CHannel PDSCH respectively; and determining, by the user equipment, an ACK/NACK channel of the PDSCH in the multiple component carriers for feeding back the ACK/NACK message, according to a Control Channel Element CCE index of the PDCCH of the primary component carrier having been set.

A method for feeding back an acknowledgement/negative-acknowledgement ACK/NACK message in a multi-carrier system, wherein an ACK/NACK channel is respectively determined for multiple component carriers, and the method further comprises: determining, by user equipment, whether a downlink data signal sent over at least two component carriers via a Physical Downlink Shared CHannel PDSCH is received; and if yes, selecting two from the determined ACK/NACK channel for sending the ACK/NACK message fed back, or otherwise, feeding back the ACK/NACK message via the ACK/NACK channel of a component carrier that receives the downlink data signal via the PDSCH.

A method for feeding back an acknowledgement/negative-acknowledgement ACK/NACK message, wherein one or two ACK/NACK channels are selected for each component carrier, and the method comprises: performing Quadrature Phase Shift Keying QPSK symbol mapping, so that QPSK symbols used for the mapping of the ACK/NACK message fed back via the selected ACK/NACK channel with respect to different component carriers are different from each other; and sending the ACK/NACK message mapped with the QPSK symbol via the selected ACK/NACK channel.

### Advantageous Effects of Invention

As can be see from the above technical solutions, in the present invention, when the ACK/NACK channel for feeding back the ACK/NACK message is determined in the multi-carrier system, the determination is performed according to the CCE index of the PDCCH of the primary component carrier for sending the downlink control signal. In the present invention, when the ACK/NACK message is fed back via the determined ACK/NACK channel, if the downlink control signal sent over at least two component carriers via the PDSCH is received, two is selected from the determined ACK/NACK channel to feed back the ACK/NACK message. Otherwise, the ACK/NACK message is sent via the ACK/NACK channel of the component carrier that receives the downlink control signal. When the ACK/NACK message is fed back via the determined ACK/NACK channel and the sending is performed after the mapping is conducted, one or two ACK/NACK channels are selected for each component carrier, and the QPSK symbol mapping is performed when the ACK/NACK message is sent, thus to ensure that the QPSK symbols used for the mapping of the ACK/NACK message fed back via the ACK/NACK channel with respect to different component carriers are different from each other. Thus, the method provided by the present invention implements the feedback of the ACK/NACK message in the multi-carrier system.

### BRIEF DESCRIPTION OF DRAWINGS

FIG. 1 is a schematic diagram illustrating time-frequency resources occupied by a PUCCH in an LTE communication system in the prior art;

FIG. 2 is a schematic diagram illustrating an ACK/NACK message sent via an uplink sub-frame corresponding to multiple downlink sub-frames in the prior art;

FIG. 3 is a schematic diagram illustrating multiple carriers in the prior art;

FIG. 4 is a flow chart illustrating a method 1 for feeding back an ACK/NACK message in a multi-carrier system according to the present invention;

FIG. 5 is a flow chart illustrating a method 2 for feeding back the ACK/NACK message in the multi-carrier system according to the present invention;

FIG. 6 is a flow chart illustrating a third embodiment of the method 2 for feeding back the ACK/NACK message in the multi-carrier system according to the present invention;

FIG. 7 is a flow chart illustrating a fourth embodiment of the method 2 for feeding back the ACK/NACK message in the multi-carrier system according to the present invention;

FIG. 8 is a flow chart illustrating a fifth embodiment of the method 2 for feeding back the ACK/NACK message in the multi-carrier system according to the present invention;

FIG. 9 is a flow chart illustrating a method 3 for feeding back the ACK/NACK message in the multi-carrier system according to the present invention;

FIG. 10 is a flow chart illustrating a first embodiment of the method 3 for feeding back the ACK/NACK message in the multi-carrier system according to the present invention; and

FIG. 11 is a flow chart illustrating a second embodiment of the method 3 for feeding back the ACK/NACK message in the multi-carrier system according to the present invention.

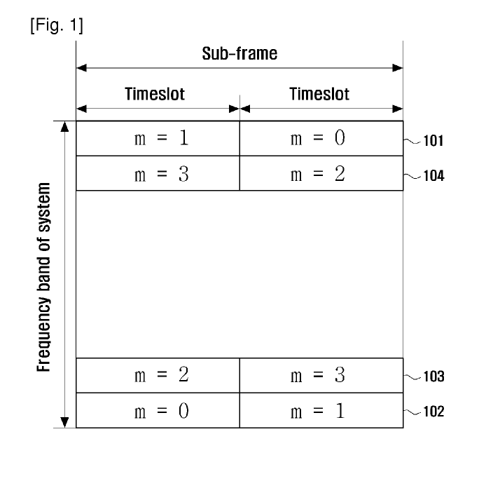

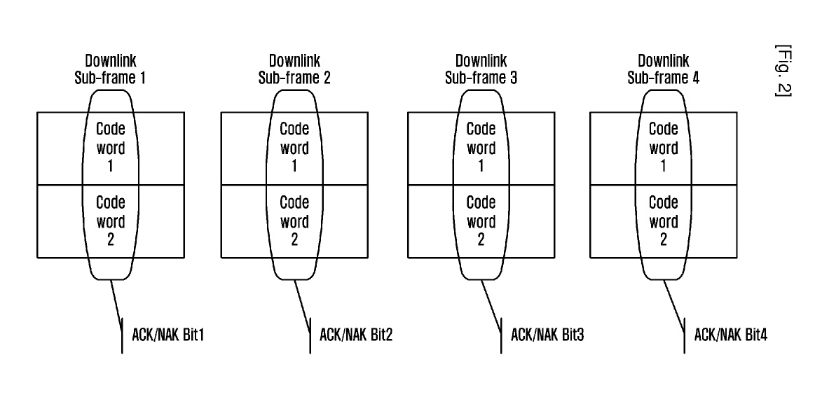

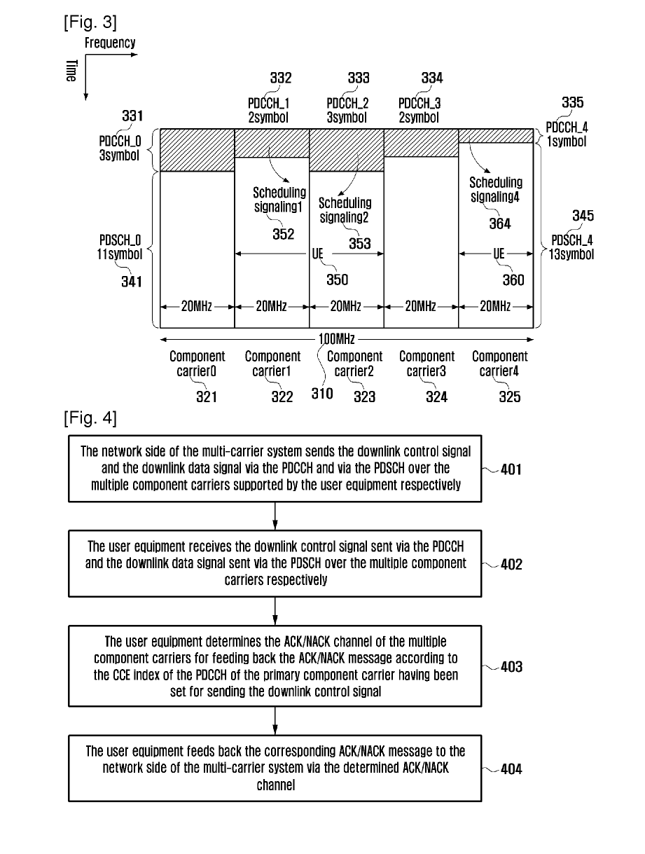

### MODE FOR THE INVENTION

To make the objects, technical solutions and advantages of the present invention more apparent, the present invention is described in more detail hereinbelow with reference to the accompanying drawings and the embodiments.

In a system using multiple carriers, such as in the LTE communication system, in each component carrier, the downlink control signal transmitted via the PDCCH and the downlink data signal transmitted via the PDSCH are (de)coded and transmitted separately. Each PDCCH corresponds to a component carrier and is used for scheduling the PDSCH of the component carrier, or scheduling the PDSCH of a component carrier other than such a component carrier. If the user equipment is configured to receive the downlink data signal over multiple component carriers, a component carrier thereof is set as a primary component carrier and the other component carrier is set as a secondary component carrier. For the downlink data signal transmitted via the PDSCH of each component carrier, the user equipment needs to feed back an ACK/NACK message via a corresponding ACK/NACK channel. The method of the present invention is well-proposed to allocate the ACK/NACK channel for multiple component carriers for feeding back the ACK/NACK message, i.e. the ACK/NACK channel of the multiple component carriers is allocated as a component carrier supported by the user equipment in the uplink, e.g. is allocated as the primary component carrier of the user equipment in the uplink.

In the multi-carrier system, each component carrier also needs to ensure the single-carrier characteristics of the uplink signal. For example, in the LTE system, the ACK/NACK message only supports 4-bit transmission, which is mainly determined by the quantity of the uplink sub-frame of the selectable ACK/NACK channel and the quantity of the uplink channel selected by the user equipment at a time.

FIG. 4 is a flow chart illustrating a method 1 for feeding back an ACK/NACK message in a multi-carrier system according to the present invention. In the multiple component carriers supported by the user equipment, one is selected and configured as the primary component carrier, and the other component carriers are as the secondary component carriers. This configuration is completed by the network side of the multi-carrier system, and is notified to the user equipment. The method includes the following.

Step 401, the network side of the multi-carrier system sends the downlink control signal and the downlink data signal via the PDCCH and via the PDSCH over the multiple component carriers supported by the user equipment respectively.

In this step, the network side of the multi-carrier system may be the base station of the serving cell that the user equipment belongs to.

In this step, for the dynamically-scheduled downlink data signal, the downlink control signal shall be sent to the UE via the PDCCH over every component carrier.

Step 402, the user equipment receives the downlink control signal sent via the PDCCH and the downlink data signal sent via the PDSCH over the multiple component carriers respectively.

Step 403, the user equipment determines the ACK/NACK channel of the multiple component carriers for feeding back the ACK/NACK message according to the CCE index of the PDCCH of the primary component carrier having been set for sending the downlink control signal.

In this step, the CCE index of the PDCCH of the primary component carrier having been set for sending the downlink control signal may be the minimum CCE index, or another CCE index, or multiple CCE indexes.

Step 404, the user equipment feeds back the corresponding ACK/NACK message to the network side of the multi-carrier system via the determined ACK/NACK channel.

In FIG. 4, there are three manners (respectively described in the following) for the user equipment to determine the ACK/NACK channel of the multiple component carriers for feeding back the ACK/NACK message according to the CCE index of the PDCCH of the primary component carrier having been set.

The first manner: the user equipment determines the ACK/NACK channel that corresponds to the PDSCH of the component carrier according to the CCE index of the PDCCH of the primary component carrier having been set and the index of the component carrier that sends the downlink data signal via the PDSCH.

If it is assumed that the CCE index (such as the minimum CCE index) of the PDCCH of the primary carrier component for sending the downlink control signal is

n_{CCE},

the index of the ACK/NACK channel corresponding to the PDSCH of the kth secondary component carrier is

n_{PUCCH}⁽¹⁾=n_{CCE}+f(k)+N_{PUCCH}⁽¹⁾,

where

f(k)

is a function of k (the present invention is not limited to a specific form of

f(k)).

Correspondingly, the multi-carrier system such as a Time Division Duplex (TDD) system is used, it is assumed that: in each component carrier supported by the user equipment, there are M downlink sub-frames the CCE of which corresponds to the ACK/NACK channel; the set of the index of the multiple downlink sub-frames (M downlink sub-frames) that act as the PDSCH is J; and the CCE index in the j^{th} downlink sub-frame within the set J of the kth component carrier is

n_{CCE,j}.

Firstly, p that satisfies

Nₚ≦n_{CCE,j}+f(k)<Nₚ₊₁

and

Nₚ=max{0, └[N_{RB}^{DL}×(N_{sc}^{RB}×p−4)]/36┘}

is selected in the bit set {0, 1, 2, 3} of the uplink sub-frame of the ACK/NACK channel, where

N_{RB}^{DL}

represents the quantity of the RB occupied by the PDCCH and

N_{SC}^{RB}

represents the quantity of the sub-carrier occupied by the RB. Thus, the index of the ACK/NACK channel corresponding to the CCE is

n_{PUCCH,i}⁽¹⁾=(M−i−1)×Nₚ+i×Nₚ₊₁+n_{CCE,j}+f(k)+N_{PUCCH}⁽¹⁾,

where

N_{PUCCH}⁽¹⁾

is a parameter configured in a higher layer. To facilitate the description of the present invention, the formula for determining the ACK/NACK channel in the multi-carrier Frequency Division Duplex (FDD) system and the multi-carrier Time Division Duplex (TDD) system may be uniformed as

n_{PUCCH}⁽¹⁾=g(n_{CCE}+f(k))+N_{PUCCH}⁽¹⁾

The present invention provides several specific forms for

f(k).

k may be the identifier of the component carrier of the serving cell. For example, if it is assumed that the multi-carrier system contains N component carriers, the identifier of each component carrier is

k=0, 1, . . . , N−1

respectively. In the embodiment, if it is assumed that the identifier of the downlink reference component carrier is

k₀,

the several forms are

f(k)=k−k₀,

f(k)=c·(k−k₀),

f(k)=mod(k−k₀,N),

and

f(k)=c·mod(k−k₀,N),

where c is a parameter configured in a higher layer or a predefined constant. k may alternatively be the index of the multiple component carriers over which the user equipment receives the downlink data signal in multiple component carriers currently. It is assumed that the user equipment receives the downlink data signal sent over M component carriers via the PDSCH, where M is no more than N (N is the multiple component carriers supported by the user equipment), i.e. the identifier of the M component carriers is

k=0, 1, . . . , M−1

respectively, and the index of the primary component carrier is typically configured as 0. Thus,

f(k)=k

f(k)=c·k,

where c is a parameter configured in a higher layer or a predefined constant.

The second manner: the user equipment determines the ACK/NACK channel that corresponds to the PDSCH of the multiple component carriers according to the CCE index of the PDCCH of the primary component carrier having been set and the state information for indicating whether each component carrier is transmitting the downlink data signal currently.

Specifically, the state information for indicating whether each component carrier is transmitting the downlink data signal currently refers to whether the bit corresponding to the index k of the component carrier is set: being set means that the downlink data signal is being sent to the user equipment currently; otherwise, it means that no downlink data signal is being sent to the user equipment currently.

Here, a dynamic PDSCH (in the case that the downlink data signal of a general service is transmitted) or a PDSCH (in the case that a Semi-Persistent Service (SPS) is transmitted, where the PDSCH is scheduled only once) is scheduled in the multiple component carriers.

For example, the state information of the PDCCH of the primary component carrier for indicating whether each component carrier is transmitting the downlink data signal currently may be implemented by way of bit mapping. When the downlink data signal is sent via the PDSCH over the kth component carrier, the bit corresponding to the k is set or reset (in the case of being reset, the other component carrier that is not sending the downlink data signal is set).

Specifically, the bit corresponding to the index k of the primary component carrier is set as 0, the bit of the other secondary component carrier is sequentially from 1 correspondingly. If it is assumed that a CCE index (such as the minimum CCE index) of the PDCCH of the primary component carrier is

n_{CCE},

then when the user equipment receives the state information for indicating whether each component carrier is transmitting the downlink data signal currently via the PDCCH over the primary component carrier, in the case that the kth bit of the bit mapping in the state information is set, the ACK/NACK channel of the PDSCH of the kth component carrier is:

n_{PUCCH}⁽¹⁾=g(n_{CCE}+f(k))+N_{PUCCH}⁽¹⁾,

where k is the identifier of the component carrier.

In this embodiment, if the downlink data signal sent over the component carrier via the PDSCH is an SPS service, the ACK/NACK channel configured for the SPS service may be used, or alternatively, the ACK/NACK channel for feedback may be determined by the formula

n_{PUCCH}⁽¹⁾=g(n_{CCE}+f(k))+N_{PUCCH}⁽¹⁾

without considering whether the bit corresponding to the component carrier for transmitting the SPS service via the PDSCH is set.

The third manner: the user equipment determines the ACK/NACK channel that corresponds to the PDSCH of the multiple component carriers according to the CCE index of the PDCCH of the primary component carrier having been set and the information for indicating the component carrier that is transmitting the downlink data signal currently.

In this manner, the ACK/NACK channel is only allocated for the PDSCH of the component carrier that transmits the downlink data signal. Here, the component carrier that is transmitting the downlink data signal includes only the component carrier that is scheduling the dynamic PDSCH, or includes the component carrier that is scheduling the dynamic PDSCH and the component carrier configured with the SPS service.

The bit corresponding to the index k of the primary component carrier is set as 0, the bit of the other secondary component carrier is sequentially from 1 correspondingly. If it is assumed that a CCE index (such as the minimum CCE index) of the PDCCH of the primary component carrier is

n_{CCE},

the ACK/NACK channel corresponding to the kth component carrier that sends the downlink data signal via the PDSCH is:

n_{PUCCH}⁽¹⁾=g(n_{CCE}+f(k))+N_{PUCCH}⁽¹⁾.

In the multi-carrier system, after the ACK/NACK channel for the feedback of each component carrier is determined, how to send the ACK/NACK message via the determined ACK/NACK channel over each component carrier also becomes an urgent problem to be solved.

In the multi-carrier system, in the case that the network side of the multi-carrier system sends the downlink data signal to the user equipment over the multiple component carriers via the PDSCH, according to the method as illustrated in FIG. 4, the PDSCH of each component carrier corresponds to an ACK/NACK channel. In the multi-carrier system, the user equipment may receive and/or transmit signals via multiple antennas. Thus, if the single-carrier characteristics are met, the user equipment may send the ACK/NACK message via the multiple ACK/NACK channels that correspond to different component carriers having been allocated respectively.

At present, according to the single-carrier characteristics, if the downlink data signal sent over the component carrier via the PDSCH occupies one Transmission Block (TB), there are three types of feedback information of the ACK/NACK message: ACK, NACK or DTX. If the downlink data signal sent via the PDSCH occupies two Transmission Blocks (if the MIMO techniques are employed), there are five types of feedback information of the ACK/NACK message: (ACK, ACK), (ACK, NACK), (NACK, ACK), (NACK, NACK) or DTX.

In the present invention, in order to reduce the occupied time-frequency resources and improve the feedback rate when the ACK/NACK message is fed back via the determined ACK/NACK channel, when the downlink data signal is transmitted using the MIMO techniques, the feedback information of the ACK/NACK message is processed, i.e. the ACK is output if both of the two Transmission Blocks correspond to the ACK, the NACK is output if any of the Transmission Blocks correspond to the NACK, and there is further a piece of feedback information of the DTX. Such a process is called spatial sub-bundling in the present invention.

In the multi-carrier system, there are three types of feedback information contained in the ACK/NACK message sent by the user equipment for each component carrier: ACK, NACK or DTX. In the multi-carrier system, the user equipment is configured to receive the downlink data signal via the PDSCH over multiple component carriers. Thus during the feedback, there are

3^{N}

types of feedback states for the ACK/NACK message sent via the determined ACK/NACK channel, which correspond to feedback information of

ceil(log₂(3^{N}))

bits. Thus, to maximize the feedback information amount may ensure the optimization of the PDSCH transmission. However, a large amount of time-frequency resources being occupied in the uplink may reduce the coverage range of the uplink control signal. Therefore, in the present invention, after the user equipment receives the downlink data signal via the PDSCH over multiple component carriers, the user equipment selects the ACK/NACK channel that corresponds to the PDSCH of two component carriers from the determined ACK/NACK channel to send the ACK/NACK message. Moreover, after the user equipment receives the downlink data signal via the PDSCH over only one component carrier, the user equipment sends the ACK/NACK message via the ACK/NACK channel that corresponds to the PDSCH of such a component carrier.

In the present invention, it should be noted here that, the PDCCH of the component carrier may be composed of multiple CCEs, thus two or more ACK/NACK channels may be determined according to the CCE index of the PDCCH of the component carrier to send the ACK/NACK message. At this time, the function of the user equipment for receiving and/or transmitting signals via multiple antennas may thus be fully used, therefore improving the performance of feeding back the ACK/NACK message.

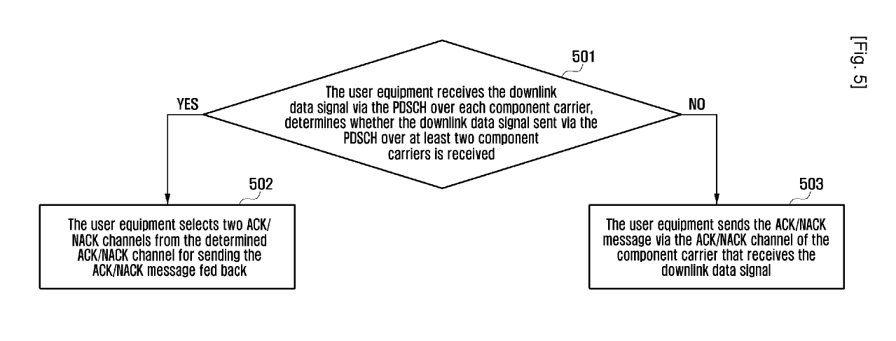

FIG. 5 is a flow chart illustrating a method 2 for feeding back the ACK/NACK message in the multi-carrier system according to the present invention. The specific steps are as follows.

Step 501, the user equipment receives the downlink data signal via the PDSCH over each component carrier, determines whether the downlink data signal sent via the PDSCH over at least two component carriers is received; and if yes, Step 502 is executed, or otherwise, Step 503 is executed.

Step 502, the user equipment selects two ACK/NACK channels from the determined ACK/NACK channel for sending the ACK/NACK message fed back.

Step 503, the user equipment sends the ACK/NACK message via the ACK/NACK channel of the component carrier that receives the downlink data signal.

For the process illustrated in FIG. 5, there are five specific embodiments that may be implemented respectively. Detailed description is as follows.

### First Embodiment

In order to save the time-frequency resources occupied by the ACK/NACK message, for the feedback information of the ACK/NACK message of the ACK/NACK channel of the component carrier, the NACK and the DTX may be taken as a piece of feedback information and the ACK may be taken as another piece of feedback information. Thus, for the feedback information of the ACK/NACK message of the ACK/NACK channel of the component carrier, there are only two states included. In the case of setting the user equipment to receive the downlink data signal via the PDSCH over N component carriers, when the ACK/NACK message is fed back, it is required to indicate 2N types of feedback states, which correspond to feedback information of

ceil(log₂(2^{N}))

bits. Specifically, the feedback information DTX means that no downlink data signal is received over the corresponding component carrier, i.e. no ACK/NACK channel for feedback is allocated for the corresponding component carrier. Although the feedback information NACK means that the ACK/NACK channel for feedback is allocated for the corresponding component carrier, in this embodiment, the NACK and the DTX share the same feedback information and are not differentiated from each other. Thus the ACK/NACK channel bearing the NACK feedback information cannot be used to transmit ACK/NACK information. Therefore, only when the feedback information of the ACK/NACK channel over at least two carrier components is the ACK, can the user equipment select two from the determined ACK/NACK channel to send the ACK/NACK message. If the feedback information of the ACK/NACK channel over only one carrier component is the ACK, the user equipment may send the ACK/NACK message only via such an ACK/NACK channel. At this time, the function of the user equipment for receiving and/or transmitting signals via multiple antennas, e.g. the ACK/NACK information is sent via two antennas using two amplifiers at the same time to thus obtain a spatial diversity gain, cannot be fully used.

In the present invention, it should be noted here that, the PDCCH of the component carrier may be composed of multiple CCEs, thus two or more ACK/NACK channels may be determined according to the CCE index of the PDCCH of the component carrier to send the ACK/NACK message. At this time, the function of the user equipment for receiving and/or transmitting signals via multiple antennas may thus be fully used, therefore improving the performance of feeding back the ACK/NACK message.

Table 1 is an example of the first embodiment that the user equipment receives the downlink data signal via the PDSCH over the carrier component where N=3 and the feedback information is mapped to the selected ACK/NACK channel. Here, it is assumed that the PDSCH of each carrier component only corresponds to one ACK/NACK channel, and it is only the selected ACK/NACK channel that is illustrated and it is not limited to which QPSK symbol is used for the selected ACK/NACK channel to perform mapping. AN . . . (k) represents that the PDSCH of the kth component carrier only corresponds to one ACK/NACK channel.

TABLE 1
Table 1:NACK and DTX share the same feedback state

| ACK/NACK message of component carrier 1, | Selected |
|---|---|
| component carrier 2 and component carrier 3 | ACK/NACK channel |
| ACK, ACK, ACK | AN_0, AN_1 |
| ACK, ACK, NACK/DTX | AN_0, AN_1 |
| ACK, NACK/DTX, ACK | AN_0, AN_2 |
| NACK/DTX, ACK, ACK | AN_1, AN_2 |
| ACK, NACK/DTX, NACK/DTX | AN_0 |
| NACK/DTX, ACK, NACK/DTX | AN_1 |
| NACK/DTX, NACK/DTX, ACK | AN_2 |
| NACK/DTX, NACK/DTX, NACK/DTX | None |

### Second Embodiment

In this embodiment, when the component carrier sends the downlink data signal via the PDSCH, the user equipment differentiates the situation of receiving the downlink data signal, i.e. the ACK, as well as the situation that the user equipment receives the downlink data signal over one or more component carriers but detects it out as the NACK. For the situation that the user equipment receives no downlink data signal over the component carrier, i.e. the DTX, the user equipment does not feed back. The situation that the user equipment receives the downlink data signal over one or more component carriers but detects it out as the NACK is not differentiated from the DTX feedback information in the first embodiment, which results in the increased probability that the user equipment is in the DTX state, thus affecting the reliability that the network side of the multi-carrier system transmits the downlink data signal.

Specifically, this embodiment includes the following: for the feedback information of the ACK/NACK message of the ACK/NACK channel of a component carrier, the NACK and the DTX share a feedback state, and the ACK uses another feedback state; for the feedback information of the ACK/NACK message of the ACK/NACK channel of multiple component carriers, N feedback states are used to indicate that the user equipment receives the downlink data signal over at least one component carrier and the feedback information of every component carrier is the NACK; and for the other situation, the NACK and the DTX share a feedback state, and the ACK uses another feedback state. Thus, the ACK/NACK message needs to indicate

2^{N}+N

feedback states, which correspond to feedback information of

ceil(log₂(2^{N}+N))

bits.

In this embodiment, only when the feedback information of the ACK/NACK channel over at least two carrier components is the ACK, can the user equipment select the ACK/NACK channel of the component carrier over which the user equipment receives the downlink data signal to send the ACK/NACK message. If the feedback information of the ACK/NACK channel over only one carrier component is the ACK, the user equipment may send the ACK/NACK message only via such an ACK/NACK channel. If the feedback information of the ACK/NACK channel of one or more carrier components is the NACK, the user equipment sends the ACK/NACK message via the ACK/NACK channel of a component carrier over which the downlink data signal is received.

In this case, if the UE receives the downlink data signal via the PDSCH over multiple component carriers, in the case that only one piece of feedback information is the ACK or the feedback information of every component carrier is the NACK, the ACK/NACK message can be sent only via the ACK/NACK channel of one component carrier. At this time, the function of the user equipment for receiving and/or transmitting signals via multiple antennas, e.g. the ACK/NACK information is sent via two antennas using two amplifiers at the same time to thus obtain a spatial diversity gain, cannot be fully used.

In the present invention, it should be noted here that, the PDCCH of the component carrier may be composed of multiple CCEs, thus two or more ACK/NACK channels may be determined according to the CCE index of the PDCCH of the component carrier to send the ACK/NACK message. At this time, the function of the user equipment for receiving and/or transmitting signals via multiple antennas may thus be fully used, therefore improving the performance of feeding back the ACK/NACK message.

Table 2 is an example of the second embodiment that the user equipment receives the downlink data signal via the PDSCH over the carrier component where N=3 and the feedback information is mapped to the selected ACK/NACK channel. Here, it is assumed that the PDSCH of each carrier component only corresponds to one ACK/NACK channel, and it is only the selected ACK/NACK channel that is illustrated and it is not limited to which QPSK symbol is used by the selected ACK/NACK channel to perform mapping.

TABLE 2
Table 2: The user equipment does not feed back information when no
downlink data signal is received over any component carrier

| ACK/NACK message of component carrier 1, | Selected |
|---|---|
| component carrier 2 and component carrier 3 | ACK/NACK channel |
| ACK, ACK, ACK | AN_0, AN_1 |
| ACK, ACK, NACK/DTX | AN_0, AN_1 |
| ACK, NACK/DTX, ACK | AN_0, AN_2 |
| NACK/DTX, ACK, ACK | AN_1, AN_2 |
| ACK, NACK/DTX, NACK/DTX | AN_0 |
| NACK/DTX, ACK, NACK/DTX | AN_1 |
| NACK/DTX, NACK/DTX, ACK | AN_2 |
| NACK, NACK/DTX, NACK/DTX | AN_0 |
| DTX, NACK, NACK/DTX | AN_1 |
| DTX, DTX, NACK | AN_2 |
| DTX, DTX, DTX | None |

### Third Embodiment

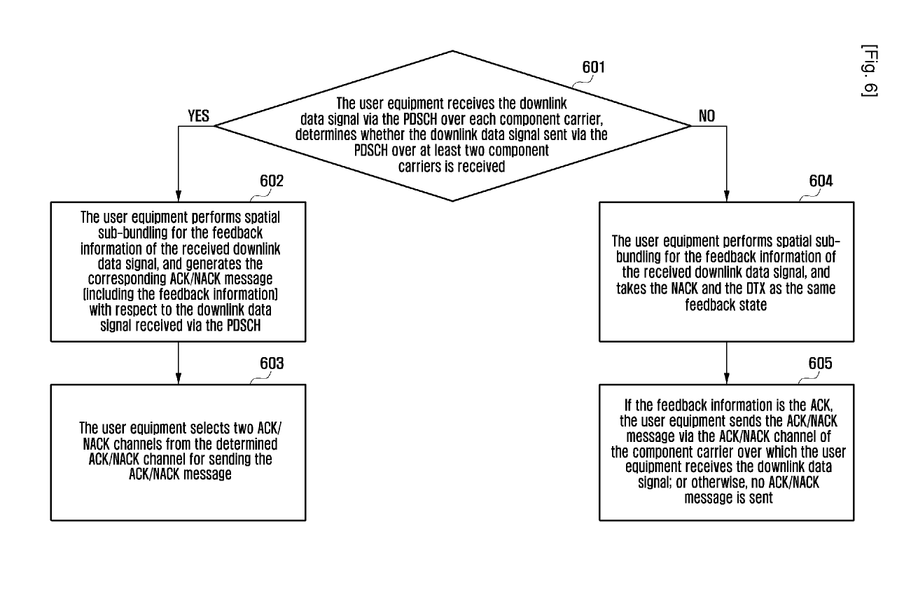

This embodiment is as illustrated in FIG. 6. FIG. 6 is a flow chart illustrating a third embodiment of the method 2 for feeding back the ACK/NACK message in the multi-carrier system according to the present invention. The specific steps are as follows.

Step 601, the user equipment receives the downlink data signal via the PDSCH over each component carrier, determines whether the downlink data signal sent via the PDSCH over at least two component carriers is received; and if yes, Step 602 is executed, or otherwise, Step 604 is executed.

Step 602, the user equipment performs spatial sub-bundling for the feedback information of the received downlink data signal, and generates the corresponding ACK/NACK message (including the feedback information) with respect to the downlink data signal received via the PDSCH.

Step 603, the user equipment selects two ACK/NACK channels from the determined ACK/NACK channel for sending the ACK/NACK message.

Step 604, the user equipment performs spatial sub-bundling for the feedback information of the received downlink data signal, and takes the NACK and the DTX as the same feedback state.

Step 605, if the feedback information is the ACK, the user equipment sends the ACK/NACK message via the ACK/NACK channel of the component carrier over which the user equipment receives the downlink data signal; or otherwise, no ACK/NACK message is sent.

In this embodiment, the user equipment feeds back the ACK/NACK message if receiving the downlink data signal via the PDSCH over only one component carrier, where the NACK and the DTX share a feedback state, and the ACK uses another feedback state. The user equipment feeds back the ACK/NACK message if receiving the downlink data signal via the PDSCH over multiple component carriers; uses

2·C_{N}²

feedback states to differentiate the feedback information of the downlink data signal received by the user equipment over the multiple component carriers, where the feedback information of a component carrier is the ACK, the feedback information of another component carrier is the NACK, and the feedback information of the other component carrier is the NACK or the DTX; uses

C_{N}²

feedback states to differentiate that the feedback information of the downlink data signal received by the user equipment over at least two component carriers is the NACK and the feedback information of the other component carrier is the NACK or the DTX; and to indicate that the feedback information of the downlink data signal received by the user equipment over at least two component carriers is the ACK and the feedback information of the other component carrier is the NACK or the DTX. Thus, it is required to include

2^{N}+3·C_{N}²

feedback states for the ACK/NACK message, which correspond to feedback information of

ceil(log₂(2^{N}+3·C_{N}²))

bits. Here,

Cₙ^{M}

is the combination of selecting m elements from n elements.

Therefore, if only receiving the downlink data signal over at least two carrier components, the user equipment may select two ACK/NACK channels from the determined ACK/NACK channel to send the ACK/NACK message, thus making a full use of the function of the user equipment for receiving and/or transmitting signals via multiple antennas. If receiving the downlink data signal over only one carrier component, the user equipment may send the ACK/NACK message via the ACK/NACK channel of only one carrier component.

In the present invention, it should be noted here that, the PDCCH of the component carrier may be composed of multiple CCEs, thus two or more ACK/NACK channels may be determined according to the CCE index of the PDCCH of the component carrier to send the ACK/NACK message. At this time, the function of the user equipment for receiving and/or transmitting signals via multiple antennas may thus be fully used, therefore improving the performance of feeding back the ACK/NACK message.

In this embodiment, if the user equipment receives the downlink data signal over multiple component carriers and at least two pieces of feedback information are the ACK, the ACK/NACK channel of two component carriers is selected from the component carrier the feedback information of which is the ACK to send the ACK/NACK message. If the user equipment receives the downlink data signal over multiple component carriers and only one piece of feedback information is the ACK, the ACK/NACK channel of the component carrier the feedback information of which is the ACK together with the ACK/NACK channel of a component carrier selected from the component carrier the feedback information of which is the NACK are selected to send the ACK/NACK. If the user equipment receives the downlink data signal over multiple component carriers and all of the feedback information is the NACK, the ACK/NACK channel of two component carriers is selected from the component carrier the feedback information of which is the NACK to send the ACK/NACK message.

Table 3 is an example of the third embodiment that the user equipment receives the downlink data signal via the PDSCH over the carrier component where N=3 and the feedback information is mapped to the selected ACK/NACK channel. Here, it is assumed that the PDSCH of each carrier component only corresponds to one ACK/NACK channel, and it is only the selected ACK/NACK channel that is illustrated and it is not limited to which QPSK symbol is used by the selected ACK/NACK channel to perform mapping.

TABLE 3
Table 3: If only the downlink data signal is received over at
least two carrier components, two ACK/NACK channels are selected

| ACK/NACK message of component carrier 1, | Selected |
|---|---|
| component carrier 2 and component carrier 3 | ACK/NACK channel |
| ACK, ACK, ACK | AN_0, AN_1 |
| ACK, ACK, NACK/DTX | AN_0, AN_1 |
| ACK, NACK, NACK/DTX | AN_0, AN_1 |
| NACK, ACK, NACK/DTX | AN_0, AN_1 |
| NACK, NACK, NACK/DTX | AN_0, AN_1 |
| ACK, NACK/DTX, ACK | AN_0, AN_2 |
| ACK, DTX, NACK | AN_0, AN_2 |
| NACK, NACK/DTX, ACK | AN_0, AN_2 |
| NACK, DTX, NACK | AN_0, AN_2 |
| NACK/DTX, ACK, ACK | AN_1, AN_2 |
| DTX, ACK, NACK | AN_1, AN_2 |
| DTX, NACK, ACK | AN_1, AN_2 |
| DTX, NACK, NACK | AN_1, AN_2 |
| ACK, DTX, DTX | AN_0 |
| DTX, ACK, DTX | AN_1 |
| DTX, DTX, ACK | AN_2 |
| NACK, DTX, DTX | None |
| DTX, NACK, DTX | |
| DTX, DTX, NACK | |
| DTX, DTX, DTX | |

### Fourth Embodiment

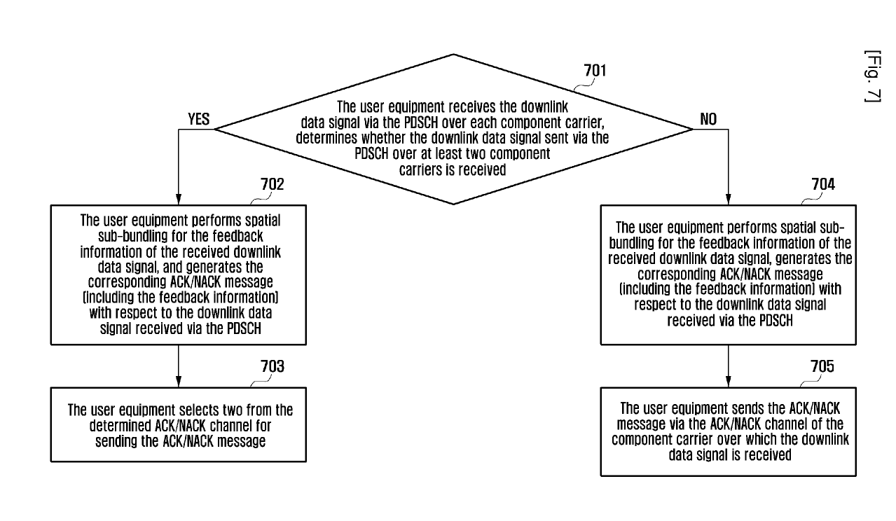

This embodiment is as illustrated in FIG. 7. FIG. 7 is a flow chart illustrating a fourth embodiment of the method 2 for feeding back the ACK/NACK message in the multi-carrier system according to the present invention. The specific steps are as follows.

Step 701, the user equipment receives the downlink data signal via the PDSCH over each component carrier, determines whether the downlink data signal sent via the PDSCH over at least two component carriers is received; and if yes, Step 702 is executed, or otherwise, Step 704 is executed.

Step 702, the user equipment performs spatial sub-bundling for the feedback information of the received downlink data signal, and generates the corresponding ACK/NACK message (including the feedback information) with respect to the downlink data signal received via the PDSCH.

Step 703, the user equipment selects two from the determined ACK/NACK channel for sending the ACK/NACK message.

Step 704, the user equipment performs spatial sub-bundling for the feedback information of the received downlink data signal, generates the corresponding ACK/NACK message (including the feedback information) with respect to the downlink data signal received via the PDSCH, and differentiates the three types of feedback information ACK, NACK and DTX.

Step 705, the user equipment sends the ACK/NACK message via the ACK/NACK channel of the component carrier over which the downlink data signal is received.

In this embodiment, the situation that the user equipment receives the downlink data signal over only one component carrier and the situation that the user equipment receives the downlink data signal over at least two component carriers are differentiated, and the situation that no downlink data signal is received over any component carrier and the situation that the downlink data signal is received over one or more component carriers but the feedback information is the NACK are also differentiated.

In this embodiment, the user equipment feeds back the ACK/NACK message if the downlink data signal is received via the PDSCH over only one component carrier, and the three types of information ACK, NACK and DTX are differentiated. Thus, N feedback states are used to indicate that the feedback information of the downlink data signal received over this component carrier is the ACK, and N feedback states are used to indicate that the feedback information of the downlink data signal received over this component carrier is the NACK. The user equipment feeds back the ACK/NACK message if receiving the downlink data signal via the PDSCH in multiple component carriers; uses

2·C_{N}²

feedback states to differentiate the feedback information that the user equipment receives the downlink data signal over multiple component carriers, where the feedback information of a component carrier is the ACK, the feedback information of another component carrier is the NACK, and the feedback information of the other component carrier is the NACK or the DTX; uses

C_{N}²

feedback states to differentiate that the feedback information of the downlink data signal received by the user equipment over at least two component carriers is the NACK and the feedback information of the other component carrier is the NACK or the DTX; and to indicate that the feedback information of the downlink data signal received by the user equipment over at least two component carriers is the ACK and the feedback information of the other component carrier is the NACK or the DTX. Thus, it is required to include

2^{N}+3˜C_{N}^{2+N}

feedback states for the ACK/NACK message, which correspond to feedback information of

ceil(log₂(2^{N}3·C_{N}²+N))

bits.

Therefore, if only receiving the downlink data signal over at least two carrier components, the user equipment may select the ACK/NACK channel of the component carrier over which the user equipment receives the downlink data signal to send the ACK/NACK message, thus making a full use of the function of the user equipment for receiving and/or transmitting signals via multiple antennas. If receiving the downlink data signal over only one carrier component, the user equipment may send the ACK/NACK message via the ACK/NACK channel of only one carrier component.

In the present invention, it should be noted here that, the PDCCH of the component carrier may be composed of multiple CCEs, thus two or more ACK/NACK channels may be determined according to the CCE index of the PDCCH of the component carrier to send the ACK/NACK message. At this time, the function of the user equipment for receiving and/or transmitting signals via multiple antennas may thus be fully used, therefore improving the performance of feeding back the ACK/NACK message.

In this embodiment, if the user equipment receives the downlink data signal over multiple component carriers and at least two pieces of feedback information are the ACK, the ACK/NACK channel of two component carriers is selected from the component carrier the feedback information of which is the ACK to send the ACK/NACK message. If the user equipment receives the downlink data signal over multiple component carriers and only one piece of feedback information is the ACK, the ACK/NACK channel of the component carrier the feedback information of which is the ACK together with the ACK/NACK channel of a component carrier selected from the component carrier the feedback information of which is the NACK are selected to send the ACK/NACK. If the user equipment receives the downlink data signal over multiple component carriers and all of the feedback information is the NACK, the ACK/NACK channel of two component carriers is selected from the component carrier the feedback information of which is the NACK to send the ACK/NACK message.

Table 4 is an example of the third embodiment that the user equipment receives the downlink data signal via the PDSCH over the carrier component where N=3 and the feedback information is mapped to the selected ACK/NACK channel. Here, it is assumed that the PDSCH of each carrier component only corresponds to one ACK/NACK channel, and it is only the selected ACK/NACK channel that is illustrated and it is not limited to which QPSK symbol is used by the selected ACK/NACK channel to perform mapping.

TABLE 4
Table 4: If only the downlink data signal is received over at
least two carrier components, two ACK/NACK channels are selected,
and no ACK/NACK message is fed back if no downlink data signal is
received over any carrier component.

| ACK/NACK message of component carrier 1, | Selected |
|---|---|
| component carrier 2 and component carrier 3 | ACK/NACK channel |
| ACK, ACK, ACK | AN_0, AN_1 |
| ACK, ACK, NACK/DTX | AN_0, AN_1 |
| ACK, NACK, NACK/DTX | AN_0, AN_1 |
| NACK, ACK, NACK/DTX | AN_0, AN_1 |
| NACK, NACK, NACK/DTX | AN_0, AN_1 |
| ACK, NACK/DTX, ACK | AN_0, AN_2 |
| ACK, DTX, NACK | AN_0, AN_2 |
| NACK, NACK/DTX, ACK | AN_0, AN_2 |
| NACK, DTX, NACK | AN_0, AN_2 |
| NACK/DTX, ACK, ACK | AN_1, AN_2 |
| DTX, ACK, NACK | AN_1, AN_2 |
| DTX, NACK, ACK | AN_1, AN_2 |
| DTX, NACK, NACK | AN_1, AN_2 |
| ACK, DTX, DTX | AN_0 |
| DTX, ACK, DTX | AN_1 |
| DTX, DTX, ACK | AN_2 |
| NACK, DTX, DTX | AN_0 |
| DTX, NACK, DTX | AN_1 |
| DTX, DTX, NACK | AN_2 |
| DTX, DTX, DTX | None |

### Fifth Embodiment

This embodiment is as illustrated in FIG. 8. FIG. 8 is a flow chart illustrating a fifth embodiment of the method 2 for feeding back the ACK/NACK message in the multi-carrier system according to the present invention. The specific steps are as follows.

Step 801, the user equipment receives the downlink data signal via the PDSCH over each component carrier, determines whether the downlink data signal sent via the PDSCH over at least two component carriers is received; and if yes, Step 802 is executed, or otherwise, Step 804 is executed.

Step 802, the user equipment performs spatial sub-bundling for the feedback information of the received downlink data signal, and generates the corresponding ACK/NACK message (including the feedback information) with respect to the downlink data signal received via the PDSCH.

Step 803, the user equipment selects two from the determined ACK/NACK channel for sending the ACK/NACK message.

Step 804, the user equipment generates the corresponding ACK/NACK message (including the feedback information of 1 bit or 2 bits) with respect to the downlink data signal received via the PDSCH, and sends the ACK/NACK message via the ACK/NACK channel of the component carrier over which the downlink data signal is received.

In this embodiment, the user equipment feeds back the ACK/NACK message if the downlink data signal is received via the PDSCH over only one component carrier, does not perform the spatial sub-bundling, and feeds back the information only via the ACK/NACK channel of such a component carrier, i.e. sends feedback information of 1 bit in the case that the downlink data signal transmitted via the PDSCH occupies one Transmission Block and the feedback information occupies 2 bits in the case that two Transmission Blocks are occupied. The user equipment feeds back the ACK/NACK message if receiving the downlink data signal via the PDSCH over multiple component carriers; uses

2·C_{N}²

feedback states to differentiate the feedback information of the downlink data signal received by the user equipment over at least two component carriers of the multiple component carriers, where the feedback information of a component carrier is the ACK, the feedback information of another component carrier is the NACK, and the feedback information of the other component carrier is the NACK or the DTX; uses

C_{N}²

feedback states to differentiate that the feedback information of the downlink data signal received by the user equipment over at least two component carriers is the NACK and the feedback information of the other component carrier is the NACK or the DTX; and to indicate that the feedback information of the downlink data signal received by the user equipment over at least two component carriers is the ACK and the feedback information of the other component carrier is the NACK or the DTX. Here,

Cₙ^{m}

is the combination of selecting m elements from n elements.

Therefore, if only receiving the downlink data signal over at least two carrier components, the user equipment may select the ACK/NACK channel of the component carrier over which the user equipment receives the downlink data signal to send the ACK/NACK message, thus making a full use of the function of the user equipment for receiving and/or transmitting signals via multiple antennas. If receiving the downlink data signal over only one carrier component, the user equipment does not perform the spatial bundling, but sends the ACK/NACK message that includes the complete feedback information via the ACK/NACK channel of such a carrier component, thus facilitating the improvement of the performance of the PDSCH transmission.

In the present invention, it should be noted here that, the PDCCH of the component carrier may be composed of multiple CCEs, thus two or more ACK/NACK channels may be determined according to the CCE index of the PDCCH of the component carrier to send the ACK/NACK message. At this time, the function of the user equipment for receiving and/or transmitting signals via multiple antennas may thus be fully used, therefore improving the performance of feeding back the ACK/NACK message.

Similarly, in this embodiment, if the user equipment receives the downlink data signal over multiple component carriers and at least two pieces of feedback information are the ACK, the ACK/NACK channel of two component carriers is selected from the component carrier the feedback information of which is the ACK to send the ACK/NACK message. If the user equipment receives the downlink data signal over multiple component carriers and only one piece of feedback information is the ACK, the ACK/NACK channel of the component carrier the feedback information of which is the ACK together with the ACK/NACK channel of a component carrier selected from the component carrier the feedback information of which is the NACK are selected to send the ACK/NACK. If the user equipment receives the downlink data signal over multiple component carriers and all of the feedback information is the NACK, the ACK/NACK channel of two component carriers is selected from the component carrier the feedback information of which is the NACK to send the ACK/NACK message.

Table 5 is an example of the third embodiment that the user equipment receives the downlink data signal via the PDSCH over the carrier component where N=3 and the feedback information is mapped to the selected ACK/NACK channel. Here, it is assumed that the PDSCH of each carrier component only corresponds to one ACK/NACK channel, and it is only the selected ACK/NACK channel that is illustrated and it is not limited to which QPSK symbol is used by the selected ACK/NACK channel to perform mapping. The parentheses represent that no spatial sub-bundling is performed for the ACK/NACK information of the downlink data signal received over the corresponding carrier component.

TABLE 5
Table 5: The user equipment receives the downlink data signal
over only one carrier component, and does not perform
the spatial sub-bundling function.

| ACK/NACK message of | |
|---|---|
| component carrier 1, component | |
| carrier 2 and component carrier 3 | Selected ACK/NACK channel |
| ACK, ACK, ACK | AN_0, AN_1 |
| ACK, ACK, NACK/DTX | AN_0, AN_1 |
| ACK, NACK, NACK/DTX | AN_0, AN_1 |
| NACK, ACK, NACK/DTX | AN_0, AN_1 |
| NACK, NACK, NACK/DTX | AN_0, AN_1 |
| ACK, NACK/DTX, ACK | AN_0, AN_2 |
| ACK, DTX, NACK | AN_0, AN_2 |
| NACK, NACK/DTX, ACK | AN_0, AN_2 |
| NACK, DTX, NACK | AN_0, AN_2 |
| NACK/DTX, ACK, ACK | AN_1, AN_2 |
| DTX, ACK, NACK | AN_1, AN_2 |
| DTX, NACK, ACK | AN_1, AN_2 |
| DTX, NACK, NACK | AN_1, AN_2 |
| (ACK, ACK), DTX, DTX | AN_0 |
| (ACK), DTX, DTX | |
| (ACK, NACK), DTX, DTX | AN_0 |
| (NACK, ACK), DTX, DTX | AN_0 |
| (NACK, NACK), DTX, DTX | AN_0 |
| (NACK), DTX, DTX | |
| DTX, (ACK, ACK), DTX | AN_1 |
| DTX, (ACK), DTX | |
| DTX, (ACK, NACK), DTX | AN_1 |
| DTX, (NACK, ACK), DTX | AN_1 |
| DTX, (NACK, NACK), DTX | AN_1 |
| DTX, (NACK), DTX | |
| DTX, DTX, (ACK, ACK) | AN_2 |
| DTX, DTX, (ACK) | |
| DTX, DTX, (ACK, NACK) | AN_2 |
| DTX, DTX, (NACK, ACK) | AN_2 |
| DTX, DTX, (NACK, NACK) | AN_2 |
| DTX, DTX, (NACK) | |
| DTX, DTX, DTX | None |

In the multi-carrier system, when receiving the downlink data signal sent over each component carrier via the PDSCH, the user equipment needs to feed back the ACK/NACK message. When the ACK/NACK message is fed back, on one hand, it is required to select the ACK/NACK channel (one or more) that corresponds to each component carrier, and on the other hand, it is required to determine how to perform the QPSK symbol mapping for the ACK/NACK message to be sent on the selected ACK/NACK channel.

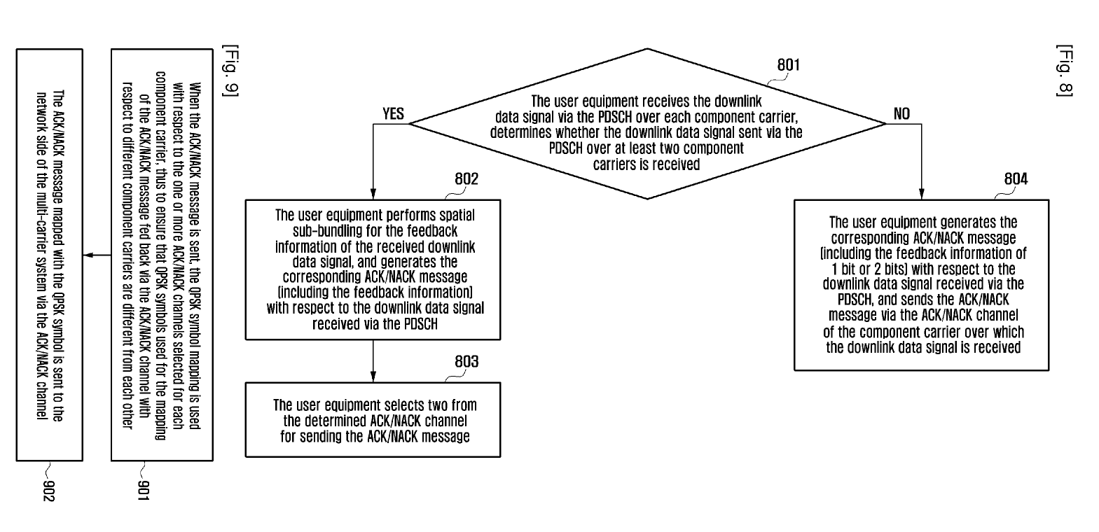

FIG. 9 is a flow chart illustrating a method 3 for feeding back the ACK/NACK message in the multi-carrier system according to the present invention. The specific steps are as follows.

Step 901, when the ACK/NACK message is sent, the QPSK symbol mapping is used with respect to the one or more ACK/NACK channels selected for each component carrier, thus to ensure that QPSK symbols used for the mapping of the ACK/NACK message fed back via the ACK/NACK channel with respect to different component carriers are different from each other.

Step 902, the ACK/NACK message mapped with the QPSK symbol is sent to the network side of the multi-carrier system via the ACK/NACK channel.

Specifically, in the present invention, there are two methods for sending the ACK/NACK message via the ACK/NACK channel using the QPSK symbol mapping, which are respectively as follows. In the first method, the ACK/NACK message to be sent is mapped using a type of QPSK symbol on the ACK/NACK channel currently selected, and the two ACK/NACK channels currently selected may use different QPSK symbols to map the ACK/NACK message to be sent. In the second method, the ACK/NACK message sent is mapped using different QPSK symbols in two different timeslots of the ACK/NACK channel currently selected, thus the ACK/NACK message sent may be mapped using 4 QPSK symbols on the two ACK/NACK channels currently selected.

According to the actual situation that the user equipment receives the downlink data signal via the component carrier and the situation that it feeds back the ACK/NACK message, the user equipment may send the ACK/NACK message via the ACK/NACK channel of one component carrier, or alternatively, may send the ACK/NACK message via the ACK/NACK channel of two component carriers. Correspondingly, the network side of the multi-carrier system has to detect various probabilities aimlessly when detecting the ACK/NACK message sent from the user equipment.

Therefore, in order to improve the reliability that the network side of the multi-carrier system detects whether the user equipment sends the ACK/NACK information via one ACK/NACK channel or via respectively two ACK/NACK channels, it is proposed in the present invention that the ACK/NACK message is mapped using different QPSK symbols on the ACK/NACK channel in the above two situations. If the case that each ACK/NACK channel uses 2 QPSK symbols (each timeslot uses a QPSK symbol) is taken as an example, there are 16 different combinations of constellation point for the 2 QPSK symbols. The 16 combinations are divided into two groups. The first group is used for the situation that the user equipment sends the ACK/NACK information via one ACK/NACK channel, e.g. this group may include 2 combinations of constellation point to indicate whether the feedback information of the user equipment is the ACK or the NACK. The second group is used for the situation that the user equipment sends the ACK/NACK information via two ACK/NACK channels respectively, e.g. this group includes the other 14 combinations of constellation point.

In the present invention, if it is assumed that the user equipment receives the downlink data signal over at least two carrier components, two ACK/NACK channels are selected to transmit the ACK/NACK message, and there are

C_{N}²

different selection combinations for the selected ACK/NACK channel. Particularly, the ACK/NACK channel corresponding to each carrier component is presented in N−1 different selection combinations.

In order to improve the reliability that the network side of the multi-carrier system differentiates the N−1 combinations that include the same ACK/NACK channel, it is proposed in the present invention that when the user equipment feeds back the ACK/NACK message via such N−1 combinations, it is preferable to perform mapping using different QPSK symbols on the ACK/NACK channel common to them. If the case that each ACK/NACK channel uses 2 QPSK symbols (each timeslot uses a QPSK symbol) is taken as an example, there are 16 different combinations of constellation point for the 2 QPSK symbols. It is further assumed that M combinations of constellation point thereof may be used for the situation that the user equipment selects 2 ACK/NACK channels to send the ACK/NACK message. The present invention seeks to reduce, as much as possible, the times that each combination of constellation point is repeatedly used in the N−1 selection combinations. Actually, if N is quite small, the case that a combination is used repeatedly in the N−1 selection combinations may totally be avoided.

The case that each ACK/NACK channel uses 2 QPSK symbols, i.e. there are 16 different combinations of constellation point for each channel, is taken as an example. Here, C_(k) is used to represent the kth combination of constellation point. The present invention is not limited to the mapping relationship between the C (k) and the specific combination of constellation point. Table 6 is an example that the QPSK symbol is allocated to the ACK/NACK channel when N=3. When N=3, it can be ensured that the combination of constellation point is not repeated, thus improving the reliability that the network side of the multi-carrier system detects different selection combinations of the ACK/NACK channel.

TABLE 6
Table 6: The QPSK symbol of each selection combination when N = 3.

| ACK/NACK message of | |
|---|---|
| component carrier 1, | |
| component carrier 2 | ACK/NACK channel and QPSK |
| and component carrier 3 | symbol |
| ACK, ACK, ACK | (AN_0, C_8), (AN_1, C_8) |
| ACK, ACK, NACK/DTX | (AN_0, C_0), (AN_1, C_0) |
| ACK, NACK, NACK/DTX | (AN_0, C_1), (AN_1, C_1) |
| NACK, ACK, NACK/DTX | (AN_0, C_2), (AN_1, C_2) |
| NACK, NACK, NACK/DTX | (AN_0, C_3), (AN_1, C_3) |
| ACK, NACK/DTX, ACK | (AN_0, C_4), (AN_2, C_0) |
| ACK, DTX, NACK | (AN_0, C_5), (AN_2, C_1) |
| NACK, NACK/DTX, ACK | (AN_0, C_6), (AN_2, C_2) |
| NACK, DTX, NACK | (AN_0, C_7), (AN_2, C_3) |
| NACK/DTX, ACK, ACK | (AN_1, C_4), (AN_2, C_4) |
| DTX, ACK, NACK | (AN_1, C_5), (AN_2, C_5) |
| DTX, NACK, ACK | (AN_1, C_6), (AN_2, C_6) |
| DTX, NACK, NACK | (AN_1, C_7), (AN_2, C_7) |

Table 7 is an example that the QPSK symbol is allocated to the ACK/NACK channel when N=5. When N=5, the combination of constellation point has to be used repeatedly for different selection combinations of the ACK/NACK channel. However, to repeat once is just enough, so as to improve, as much as possible, the reliability that the multi-carrier system detects different selection combinations of the ACK/NACK channel.

TABLE 7
Table 7: The QPSK symbol of each selection combination when N = 5.

| ACK/NACK message of component carrier 0 ~ | ACK/NACK channel and QPSK |
|---|---|
| component carrier 5 | symbol |
| ACK, ACK, ACK, ACK, ACK | (AN_0, C_0), (AN_1, C_0) |
| ACK, ACK, ACK, ACK, NACK/DTX | (AN_0, C_1), (AN_1, C_1) |
| ACK, ACK, ACK, NACK/DTX, ACK | (AN_0, C_2), (AN_2, C_0) |
| ACK, ACK, NACK/DTX, ACK, ACK | (AN_0, C_3), (AN_3, C_0) |
| ACK, NACK/DTX, ACK, ACK, ACK | (AN_2, C_1), (AN_3, C_1) |
| NACK/DTX, ACK, ACK, ACK, ACK | (AN_1, C_2), (AN_2, C_2) |
| ACK, ACK, ACK, NACK/DTX, NACK/DTX | (AN_0, C_4), (AN_2, C_3) |
| ACK, ACK, NACK/DTX, ACK, NACK/DTX | (AN_0, C_5), (AN_3, C_2) |
| ACK, NACK/DTX, ACK, ACK, NACK/DTX | (AN_2, C_4), (AN_4, C_0) |
| NACK/DTX, ACK, ACK, ACK, NACK/DTX | (AN_1, C_3), (AN_3, C_3) |
| ACK, ACK, NCK/DTX, NACK/DTX, ACK | (AN_1, C_4), (AN_4, C_1) |
| ACK, NACK/DTX, ACK, NACK/DTX, ACK | (AN_0, C_6), (AN_4, C_2) |
| NACK/DTX, ACK, ACK, NACK/DTX, ACK | (AN_1, C_5), (AN_4, C_3) |
| ACK, NACK/DTX, NACK/DTX, ACK, ACK | (AN_3, C_4), (AN_4, C_4) |
| NACK/DTX, ACK, NACK/DTX, ACK, ACK | (AN_1, C_6), (AN_3, C_5) |
| NACK/DTX, NACK/DTX, ACK, ACK, ACK | (AN_2, C_5), (AN_4, C_5) |
| ACK, ACK, NACK/DTX, NACK/DTX, NACK/DTX | (AN_0, C_0), (AN_1, C_0) |
| ACK, NACK, NACK/DTX, NACK/DTX, NACK/ | (AN_0, C_1), (AN_1, C_1) |
| DTX | |
| NACK, ACK, NACK/DTX, NACK/DTX, NACK/ | (AN_0, C_2), (AN_1, C_2) |
| DTX | |
| NACK, NACK, NACK/DTX, NACK/DTX, NACK/ | (AN_0, C_3), (AN_1, C_3) |
| DTX | |
| ACK, NACK/DTX, ACK, NACK/DTX, NACK/ | (AN_0, C_4), (AN_2, C_0) |
| DTX | |
| ACK, DTX, NACK, NACK/DTX, NACK/DTX | (AN_0, C_5), (AN_2, C_1) |
| NACK, NACK/DTX, ACK, NACK/DTX, | (AN_0, C_6), (AN_2, C_2) |
| NACK/DTX | |
| NACK, DTX, NACK, NACK/DTX, NACK/ | (AN_0, C_7), (AN_2, C_3) |
| DTX | |
| ACK, NACK/DTX, NACK/DTX, ACK, NACK/ | (AN_0, C_8), (AN_3, C_0) |
| DTX | |
| ACK, DTX, DTX, NACK, NACK/DTX | (AN_0, C_9), (AN_3, C_1) |
| NACK, NACK/DTX, NACK/DTX, ACK, | (AN_0, C_10), (AN_3, C_2) |
| NACK/DTX | |
| NACK, DTX, DTX, NACK, NACK/DTX | (AN_0, C_11), (AN_3, C_3) |
| ACK, NACK/DTX, NACK/DTX, NACK/DTX, | (AN_0, C_12), (AN_4, C_0) |
| ACK | |
| ACK, DTX, DTX, DTX, NACK | (AN_0, C_13), (AN_4, C_1) |
| NACK, NACK/DTX, NACK/DTX, NACK/DTX, | (AN_0, C_14), (AN_4, C_2) |
| ACK | |
| NACK, DTX, DTX, DTX, NACK | (AN_0, C_15), (AN_4, C_3) |
| NACK/DTX, ACK, ACK, NACK/DTX, NACK/ | (AN_1, C_4), (AN_2, C_4) |
| DTX | |
| DTX, ACK, NACK, NACK/DTX, NACK/DTX | (AN_1, C_5), (AN_2, C_5) |
| DTX, NACK, ACK, NACK/DTX, NACK/DTX | (AN_1, C_6), (AN_2, C_6) |
| DTX, NACK, NACK, NACK/DTX, NACK/ | (AN_1, C_7), (AN_2, C_7) |
| DTX | |
| NACK/DTX, ACK, NACK/DTX, ACK, NACK/ | (AN_1, C_8), (AN_3, C_4) |
| DTX | |
| DTX, ACK, DTX, NACK, NACK/DTX | (AN_1, C_9), (AN_3, C_5) |
| DTX, NACK, NACK/DTX, ACK, NACK/DTX | (AN_1, C_10), (AN_3, C_6) |
| DTX, NACK, DTX, NACK, NACK/DTX | (AN_1, C_11), (AN_3, C_7) |
| NACK/DTX, ACK, NACK/DTX, NACK/DTX, | (AN_1, C_12), (AN_4, C_4) |
| ACK | |
| DTX, ACK, DTX, DTX, NACK | (AN_1, C_13), (AN_4, C_5) |
| DTX, NACK, NACK/DTX, NACK/DTX, ACK | (AN_1, C_14), (AN_4, C_6) |
| DTX, NACK, DTX, NACK/DTX, NACK | (AN_1, C_15), (AN_4, C_7) |
| NACK/DTX, NACK/DTX, ACK, ACK, NACK/ | (AN_2, C_8), (AN_3, C_8) |
| DTX | |
| DTX, DTX, ACK, NACK, NACK/DTX | (AN_2, C_9), (AN_3, C_9) |
| DTX, DTX, NACK, ACK, NACK/DTX | (AN_2, C_10), (AN_3, C_10) |
| DTX, DTX, NACK, NACK, NACK/DTX | (AN_2, C_11), (AN_3, C_11) |
| NACK/DTX, NACK/DTX, ACK, NACK/DTX, | (AN_2, C_12), (AN_4, C_8) |
| ACK | |
| DTX, DTX, ACK, DTX, NACK | (AN_2, C_13), (AN_4, C_9) |
| DTX, DTX, NACK, NACK/DTX, ACK | (AN_2, C_14), (AN_4, C_10) |
| DTX, DTX, NACK, DTX, NACK | (AN_2, C_15), (AN_4, C_11) |
| NACK/DTX, NACK/DTX, NACK/DTX, ACK, | (AN_3, C_12), (AN_4, C_12) |
| ACK | |
| DTX, DTX, DTX, ACK, NACK | (AN_3, C_13), (AN_4, C_13) |
| DTX, DTX, DTX, NACK, ACK | (AN_3, C_14), (AN_4, C_14) |
| DTX, DTX, DTX, NACK, NACK | (AN_3, C_15), (AN_4, C_15) |

The other two methods of the present invention for sending the ACK/NACK message by mapping to the ACK/NACK channel using the QPSK symbol is described hereinbelow.

In the first method, it is assumed that the user equipment receives the downlink data signal sent over N component carriers via the PDSCH at the same time. Firstly, the quantity of the ACK/NACK message required to be fed back via the selected two ACK/NACK channel is determined. The quantity thereof is denoted as

N_{i,j},

where i and j is the index of the component carrier that the selected two ACK/NACK channels are located.

N_{i,j}

combinations of constellation point are selected for sending such

N_{i,j}

types of ACK/NACK messages via the selected two ACK/NACK channels.

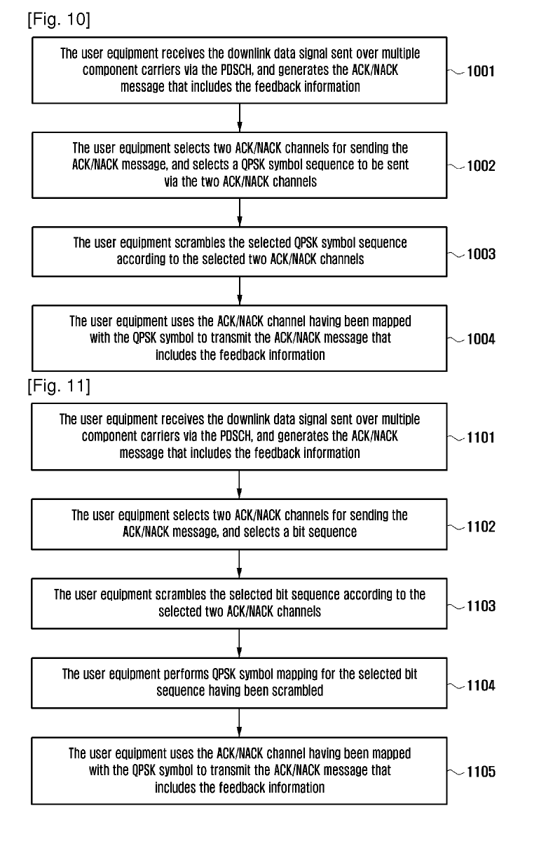

FIG. 10 is a flow chart illustrating a first embodiment of the method 3 for feeding back the ACK/NACK message in the multi-carrier system according to the present invention. The specific steps are as follows.

Step 1001, the user equipment receives the downlink data signal sent over multiple component carriers via the PDSCH, and generates the ACK/NACK message that includes the feedback information.

Step 1002, the user equipment selects two ACK/NACK channels for sending the ACK/NACK message, and selects a QPSK symbol sequence to be sent via the two ACK/NACK channels.

The QPSK symbol sequence is sent in an ACK/NACK channel, and an identical QPSK symbol sequence is sent in the two ACK/NACK channels. Alternatively, the QPSK symbol sequence is directly mapped to the two ACK/NACK channels.

Step 1003, the user equipment scrambles the selected QPSK symbol sequence according to the selected two ACK/NACK channels to obtain the QPSK symbol to be sent.

Step 1004, the user equipment uses the ACK/NACK channel having been mapped with the QPSK symbol to transmit the ACK/NACK message that includes the feedback information.

In this embodiment, the ACK/NACK channels of the selected two component carriers are different from each other, and the generated scrambling codes are different from each other. The present invention is not limited to a specific method for generating the scrambling code.

In the second method, it is assumed that the user equipment receives the downlink data signal sent over N component carriers via the PDSCH at the same time. Firstly, the quantity of the ACK/NACK message required to be fed back via the selected two ACK/NACK channel is determined. The quantity thereof is denoted as

N_{i,j},

where i and j is the index of the component carrier that the selected two ACK/NACK channels are located.

N_{i,j}

4-bit sequences are selected for sending such

N_{i,j}

types of ACK/NACK messages via the selected two ACK/NACK channels.

FIG. 11 is a flow chart illustrating a second embodiment of the method 3 for feeding back the ACK/NACK message in the multi-carrier system according to the present invention. The specific steps are as follows.

Step 1101, the user equipment receives the downlink data signal sent over multiple component carriers via the PDSCH, and generates the ACK/NACK message that includes the feedback information.

Step 1102, the user equipment selects two ACK/NACK channels for sending the ACK/NACK message, and selects a bit sequence.

The bit sequence is sent in an ACK/NACK channel after being QPSK modulated, and an identical bit sequence is sent in the two ACK/NACK channels. Alternatively, the bit sequence is directly mapped to the two ACK/NACK channels after being QPSK modulated.

Step 1103, the user equipment scrambles the selected bit sequence according to the selected two ACK/NACK channels.

Step 1104, the user equipment performs QPSK symbol mapping for the selected bit sequence having been scrambled.

Step 1105, the user equipment uses the ACK/NACK channel having been mapped with the QPSK symbol to transmit the ACK/NACK message that includes the feedback information.

In this embodiment, the ACK/NACK channels of the selected two component carriers are different from each other, and the generated scrambling codes are different from each other. The present invention is not limited to a specific method for generating the scrambling code.

The objects, technical solutions and advantages of the present invention are described in more detail hereinabove with reference to preferred embodiments. It should be understood that, the foregoing are merely the preferred embodiments of the present invention, and the scope of the present invention is not limited thereto. Any modifications, equivalents and improvements made without departing from the spirit and principle of the present invention are intended to fall into the scope of the present invention.

1. A method for feeding back an acknowledgement/negative-acknowledgement (ACK/NACK) message in a multi-carrier system, wherein in multiple component carriers a primary component carrier is set for user equipment, with others set as a secondary component carrier, the method comprising:
receiving, by the user equipment, a downlink control signal and a downlink data signal sent over the multiple component carriers via a Physical Downlink Control CHannel (PDCCH) and via a Physical Downlink Shared CHannel (PDSCH), respectively; and
determining, by the user equipment, an ACK/NACK channel of the PDSCH in the multiple component carriers for feeding back the ACK/NACK message, according to a Control Channel Element (CCE) index of the PDCCH of the primary component carrier having been set.

2. The method according to claim 1, wherein the determination of the ACK/NACK channel corresponding to the PDSCH in the multiple component carriers for feeding back the ACK/NACK message is made by n_{PUCCH}⁽¹⁾=g(n_{CCE}+f(k))+N_{PUCCH}⁽¹⁾, where n_{PUCCH}⁽¹⁾ is an index of the determined ACK/NACK channel, n_{CCE} is the CCE index of the PDCCH, N_{PUCCH}⁽¹⁾ is a parameter configured in a higher layer, f(k) is a function of a carrier component k of the multiple carrier components.

3. The method according to claim 1, wherein the determining step further comprises:
performing the determination according to the CCE index of the PDCCH of the primary component carrier and an index of a component carrier that sends the downlink data signal via the PDSCH;
performing the determination according to the CCE index of the PDCCH of the primary component carrier and included state information for indicating whether each component carrier is transmitting the downlink data signal currently; or
performing the determination according to the CCE index of the PDCCH of the primary component carrier and included information for indicating the component carrier that is transmitting the downlink data signal via the PDSCH currently.

4. The method according to claim 3, wherein the indicated component carrier that is transmitting the downlink data signal via the PDSCH currently is the component carrier scheduled with a dynamic PDSCH or configured with a semi-persistent PDSCH.

5. The method according to claim 1, wherein the CCE index of the PDCCH of the primary component carrier is the minimum CCE index.

6. A method for feeding back an acknowledgement/negative-acknowledgement (ACK/NACK) message in a multi-carrier system, wherein an ACK/NACK channel is respectively determined for multiple component carriers, the method comprising:
determining, by user equipment, whether a downlink data signal sent over at least two component carriers via a Physical Downlink Shared CHannel (PDSCH) is received; and if yes, selecting two determined ACK/NACK channels for sending the ACK/NACK message fed back, and otherwise feeding back the ACK/NACK message via the ACK/NACK channel of a component carrier that receives the downlink data signal via the PDSCH.

7. The method according to claim 6, wherein the received downlink data signal sent over the two component carriers via the PDSCH is the downlink data signal allowed to feed back ACK information;
the ACK/NACK message fed back includes ACK information or feedback information with NACK information and Discontinuous Transmission (DTX) information combined therein; and
there are 2^{N} types of feedback states for the ACK/NACK message fed back, where N is a quantity of multiple carrier components.

8. The method according to claim 6, wherein the received downlink data signal sent over the two component carriers via the PDSCH is the downlink data signal fec allowed to feed back ACK information;
the fed-back ACK/NACK message sent by selecting two determined ACK/NACK channels includes the ACK information or NACK information;
the ACK/NACK message fed back via the ACK/NACK channel of a component carrier that receives the downlink data signal via the PDSCH includes the ACK information or feedback information with the NACK information and Discontinuous Transmission DTX information combined therein; and
there are 2^{N}+N types of feedback states for the ACK/NACK message fed back, where N is a quantity of multiple carrier components.

9. The method according to claim 6, wherein the received downlink data signal sent over the two component carriers via the PDSCH is the downlink data signal allowed to feed back ACK information or/and NACK information;
the fed-back ACK/NACK message sent by selecting two determined ACK/NACK channel-channels includes the ACK information or feedback information with the NACK information and Discontinuous Transmission (DTX) information combined therein;
2·C_{N}² feedback states are used to differentiate the feedback information of the downlink data signal received by the user equipment over the multiple component carriers, wherein the feedback information over a component carrier is the ACK information, the feedback information over another component carrier is the NACK information, and the feedback information over the other component carrier is the NACK or the DTX information; and C_{N}² feedback states are used to differentiate that the feedback information of the downlink data signal received by the user equipment over the at least two component carriers is the NACK information, and the feedback information over the other component carrier is the NACK information or the DTX information, where N is quantity of the multiple component carriers;
the ACK/NACK message fed back via the ACK/NACK channel of the component carrier that receives the downlink data signal via the PDSCH includes the ACK information or the feedback information with the NACK information and the DTX information combined therein; and
there are 2^{N}+3·C_{N}² types of feedback states for the ACK/NACK message fed back, where N is a quantity of the-multiple carrier components.

10. The method according to claim 6, wherein the received downlink data signal sent over the two component carriers via the PDSCH is the downlink data signal allowed to feed back ACK information or/and NACK information;
the fed-back ACK/NACK message sent by selecting two determined ACK/NACK channel includes the ACK information or feedback information with the NACK information and Discontinuous Transmission (DTX) information combined therein;
2·C_{N}², feedback states are used to differentiate the feedback information of the downlink data signal received by the user equipment over the multiple component carriers, wherein the feedback information over a component carrier is the ACK information, the feedback information over another component carrier is the NACK information, and the feedback information over the other component carrier is the NACK information or the DTX information; C_{N}² feedback states are used to differentiate that the feedback information of the downlink data signal received by the user equipment over the at least two component carriers is the NACK information, and the feedback information over the other component carrier is the NACK or the DTX; N feedback states are used to indicate that the user equipment receives the downlink data signal over at least one component carrier and the feedback information is the NACK information;
the ACK/NACK message fed back via the ACK/NACK channel of the component carrier that receives the downlink data signal via the PDSCH includes the ACK information or the feedback information with the NACK information and the DTX information combined therein; and
there are 2^{N}+3·C_{N}²+N types of feedback states for the ACK/NACK message fed back, where N is a quantity of multiple carrier components.

11. The method according to claim 9, wherein spatial sub-bundling is performed if the feedback information included in the ACK/NACK message is the feedback information making use of Multiple Input Multiple Output (MIMO) techniques.

12. The method according to claim 6, wherein the received downlink data signal sent over the two component carriers via the PDSCH is the downlink data signal allowed to feed back ACK information or/and NACK information;
the fed-back ACK/NACK message sent by selecting two determined ACK/NACK channels includes the ACK information or feedback information with the NACK information and Discontinuous Transmission (DTX) information combined therein;
2·C_{N}² feedback states are used to differentiate the feedback information of the downlink data signal received by the user equipment over the multiple component carriers, wherein the feedback information over a component carrier is the ACK information, the feedback information over another component carrier is the NACK information, and the fed-back information over the other component carrier is the NACK information or the DTX information; C_{N}² feedback states are used to differentiate that the feedback information of the downlink data signal received by the user equipment over the at least two component carriers is the NACK information, and the feedback information of the other component carrier is the NACK information or the DTX information, where N is a quantity of multiple component carriers; and spatial sub-bundling is performed if the feedback information makes use of MIMO techniques; and
the ACK/NACK message fed back via the ACK/NACK channel of the component carrier that receives the downlink data signal via the PDSCH includes the ACK information or the feedback information with the NACK information and the DTX information combined therein, wherein 2 bits are used for transmission if the MIMO techniques are used, and 1 bit is used for transmission if the MIMO techniques are not used.

13. The method according to claim 6, wherein the process of feeding back the ACK/NACK message via the ACK/NACK channel of a component carrier that receives the downlink data signal via the PDSCH further indicates whether:
there are multiple ACK/NACK channels.

14. The method according to claim 6, wherein the method further comprises:
performing Quadrature Phase Shift Keying (QPSK) symbol mapping, so that QPSK symbols used for the mapping of the ACK/NACK message fed back via the selected ACK/NACK channel with respect to different component carriers are different from each other; and
sending the ACK/NACK message mapped with the QPSK symbol via the selected ACK/NACK channel.

15. The method according to claim 14, wherein the performing of QPSK symbol mapping further comprises:
selecting a QPSK symbol sequence and scrambling the selected QPSK symbol sequence according to the two ACK/NACK channels having been selected.

16. The method according to claim 14, wherein the process-of performing of QPSK symbol mapping further comprises:
selecting a bit sequence and performing the QPSK symbol mapping after scrambling the selected bit sequence according to the two ACK/NACK channels having been selected.

17. A method for feeding back an acknowledgement/negative-acknowledgement (ACK/NACK) message, wherein one or two ACK/NACK channels are selected for each component carrier, the method comprising:
performing Quadrature Phase Shift Keying (QPSK) symbol mapping, so that QPSK symbols used for mapping of the ACK/NACK message fed back via a selected ACK/NACK channel with respect to different component carriers are different from each other; and
sending the ACK/NACK message mapped with the QPSK symbol via the selected ACK/NACK channel.

18. The method according to claim 17, wherein the performing of QPSK symbol mapping further comprises:
selecting a QPSK symbol sequence and scrambling the selected QPSK symbol sequence according to two ACK/NACK channels having been selected.

19. The method according to claim 17, wherein the performing of QPSK symbol mapping further comprises:
selecting a bit sequence and performing the QPSK symbol mapping after scrambling the selected bit sequence according to two ACK/NACK channels having been selected.

20. The method according to claim 10, wherein spatial sub-bundling is performed if the feedback information included in the ACK/NACK message is the feedback information making use of Multiple Input Multiple Output (MIMO) techniques.
